(19) United States
(12) Patent Application Publication
(10) Pub. No.: US 2010/0001686 A1
(43) Pub. Date: Jan. 7, 2010

(54) Electric vehicle battery alternating recharging process

(76) Inventor: Michael Steven Hargett, Albany, OR (US)

Correspondence Address: Michael Steven Hargett, 5116 Norma Ct. S. E., Salem, OR, 97306-1574, US

(21) Appl. No.: 11/642,564

(22) Filed: Dec. 21, 2006

Related U.S. Application Data
(60) Provisional application No. 60/761,211, filed on Jan. 24, 2006.

(51) Int. Cl. H02J 7/00; H02K 53/00

(52) U.S. Cl. 320/109; 415/916; 180/65.21

(57) ABSTRACT

An Electric Vehicle in the past has not been a practical means of transporting people as well as goods, due to the recharging of the Batteries.

The most important negative reason is the length of time the Batteries could supply Electric current in the operation of the vehicle. The Batteries in an Electric Vehicle have kept this mode of transportation from becoming cost efficient. The recharging of the Batteries in an Electric Vehicle has taken a required amount of time to recharge. The time required has meant the Electric Vehicle could not be used. The time required to recharge the Batteries has been the major reason for not advancing the Electric Vehicle's use in a practical everyday means. The Batteries limited time of supplying electric current for use has been a contributing factor limiting the distance that is needed in everyday modern travel. This Invention uses the Alternating Battery Recharging Process, which allows the time and distance to be attained in which these negatives can be overcome.

### CLAIM OF PRIORITY

This Application is claiming priority from Provisional Patent reference No., U.S. 60/761,211.

### SUMMARY

This Invention consists of the means to allow an Electric Vehicle to travel at distances, which will make it cost efficient and practical. This Invention will allow people to use the Electric Vehicle as never before due to the great distances it can travel in transporting people and goods. The Invention will also allow the means to transport goods and people to destinations that normally would require great sums of fossil fuels. This Invention reduces the need to burn harmful fossil fuels. These fossil fuels are harmful to the Environment in various ways. A few ways to mention are the Air, Water and the impact in the world climate change. The climate is changing from what is termed Green House Gas's. The result is long term irreversible Global Warming. This Invention incorporates the alternating use of the batteries in powering of the Electric Vehicle. This alternating the battery use and the recharging of the batteries once they are used in the operation or driving of the Electric Vehicle, then charging them as they are depleted by and on board or an attachment of an electricity producing device. This device comes in many forms that would be suitable for the application. These devices will supply the proper electric current needed to fulfill the battery charging in the Battery Alternating Recharging Process.

### DESCRIPTION OF PRIOR ART AND CROSS REFERENCE APPLICATIONS AND PATENTS

There is no Prior Art to report. To reference a Provisional Patent numbered U.S. 60/761,211. There are no other Patents to report in the Patent Search. There were 0 results of any additional Patents in the search.

No Prior Art from any other sources. There are no other Patents or any Prior Art to my knowledge to report. No Prior Art or Patents connected to this Invention.

### FIELD OF INVENTION

This Invention relates to (4) fold; (1) The need to have an Electric Vehicle travel farther distances than Fossil Fuel Vehicles. (2) This Invention also address's and shortens the length of time required to recharge the batteries in an Electric Vehicle. (3) This Invention address's the need to have an Environmentally Safer Form of Travel. (4) This Invention decreases the need on Foreign Fossil Fuels, which helps the United States become less dependent on those nations that are considered to be unfriendly and in some cases an adversary to our global policy and national security.

### DESCRIPTION OF THE DRAWING

FIG (1) shows a simplified overhead view of the Electric Vehicle Chassis looking down from above. This downward overhead view is without the exterior vehicle body cover, seats, steering wheel, electric motor, transmission and other Electric Vehicle parts that are in a standard Electric Vehicle. The simplified view is to eliminate all other components so that the focus can be directed entirely on the Battery Alternating Recharging Process with its components in the Electric Vehicle only. FIG (1) shows only the basic components that are required in the function in the battery Alternating Recharging Process for the Electric Vehicle.

Number 1 in FIG (1) shows the 4 battery packs in the Electric Vehicle. These 4 battery packs are the battery packs that are used in the Battery Alternating Recharging Process. 4 battery packs are used in number 1 of FIG (1)only for the description of the this drawing. It must be noted that the number of batteries is determined by the Electric Vehicles design in attaining distance and time traveled. The number of batteries can be as many as 2, or as many as needed in any desired application.

Number 2 in FIG. (1) shows a Vehicle standard tire and wheel of an Electric Vehicle. This type tire and wheel are the same as any Fossil Fuel Vehicle that is being driven today.

Number 3 in FIG (1) shows an electricity producing device. In this drawing it is an alternator. This alternator is one of sufficient output of electricity to power the Battery Alternating Recharging Process for the Electric Vehicle in the drawing FIG (1). There are many types of electricity producing devices available that could be applied to the Battery Alternating Recharging Process. It is not necessary to name all of those in this application. Any device that produces the sufficient amounts of electricity can be used. The electricity producing device in this application generates it electricity when the wheel of the Electric Vehicle turns. The wheel turns when it is being driven. In FIG (1) these electricity producing devices are dedicated to each of the 4 wheels, these wheels are shown as number 2 in FIG (1)

Number 4 in FIG (1) shows the simple wiring that is required to operate the Battery Alternating Recharging Process. This is a simple wiring example of positive, negative, and ground wires that are attached to the electricity producing device that is number 3 in FIG (1). These electric wires run from the electricity producing device to the positive, negative and ground terminals of the batteries. Thus the wheels of the Electric Vehicle turn when the vehicle is being driven and while doing so the electricity is produced that supplies the batteries as they are be used in the Battery Alternating Recharging Process.

### PREFERRED EMBODIMENT PAGE 1

The Electric Vehicle has for many years been proven to be a costly means of travel. It is certain that a means of extending the life of an Electric Vehicle's Batteries, would make the Electric Vehicle, more efficient means to travel than a Fossil Fuel Vehicle. The cost reduction in transporting people and goods would be dropped dramatically with the Electric Vehicle Battery Alternating Recharging Process. As you can see in the Drawing of the Electric Vehicle. FIG (1) #1 shows the use of 4 batteries. These batteries can be clumped together in Packs. Individually or in packs they are used by alternating their use. The others that are depleted are being simultaneously recharged in the Battery Alternating Recharging Process. Then bringing them back on line when charged to be reused in powering the Electric Vehicle. Meeting these needs in extending the Electric Vehicle's time and distance, it can be made to travel great distances.

### PREFERRED EMBODIMENT PAGE 2

The Electric Vehicle Battery Alternating Recharging Process works as a means to extend the travel time and distance of an Electric Vehicle. The Process works this way; Taking an Electric Vehicle and equipping the Vehicle with 4 Battery packs which are in the Description of the Drawing. The 4 battery packs that are used in the Invention are for description only, there can be as many as 2 or as many as desired to achieve a certain distance or time of travel.

By using multiple Battery packs you can extend the time and distance traveled by the Electric Vehicle.

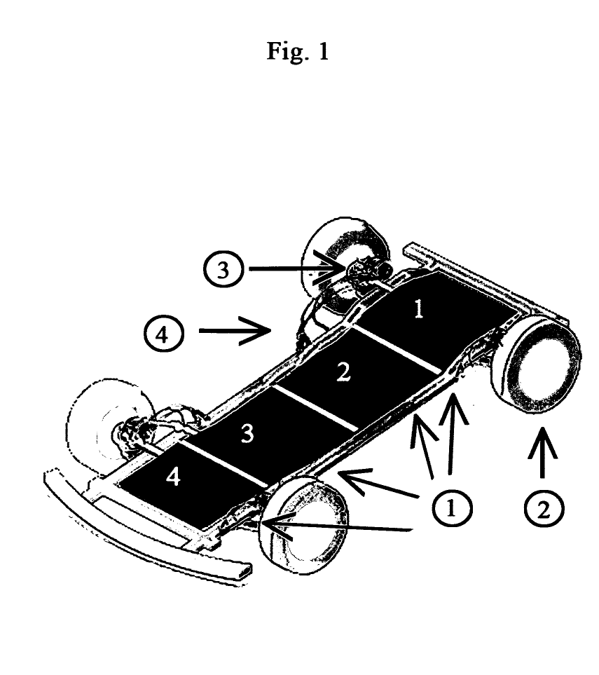

In the drawing FIG. 1, #1 are the 4 battery sections there are 4 in this drawing for this application. There can be as many batteries as needed to allow the process to recycle itself in the discharge and recharge of the Battery Alternating Recharging Process. FIG 1, #2 is a standard automotive wheel and rubber tire. FIG. 1, # 3 you can see the electricity producing devices that are attached to the Electric Vehicles wheels. These devices in the drawing are alternators specifically for this Patent application. The alternator supplies the electric current that is needed to operate the Battery Alternating Recharging Process. However the devices may be of other types, generators for an example or other devices that produce electric current. FIG. 1, #4 in the drawing are the electric wires that supply or carry the electric current from the alternators to the batteries. These wires carry the electric current to supply the depleted batteries once they have been discharged of their electricity. These same wires supply or carry the electric current that is needed for the Battery Alternating Recharging Process to be successful.

The Electric Vehicle Battery Alternating Recharging Process will create the desired time and distance that an Electric Vehicle can travel by using this Invention.

This is how the Process works;

You start off by using the # 1 Battery Pack. While the Vehicle is being driven by the #1 Battery Pack, the Electric Vehicle will sense when # 1 Battery Pack starts to be depleted. When the Electric Vehicle senses # 1's depletion, then the # 2 Battery Pack comes on line to be used to power the Electric Vehicle, as # 2 Battery Pack starts to be used, the # 1 Battery Pack goes into the Recharging Phase of the Process. As #2 begins to be depleted the Electric Vehicle senses the depletion of #2. The #3 Battery Pack comes on line to be used. As #3 is being used. # 2 Battery Pack enters the recharging process. At the time # 3 Battery Pack is being depleted the Electric Vehicle senses that depletion of #3.

#4 Battery Pack comes on line to be used. #3 Battery Pack enters the recharging process. When # 4 Battery Pack is depleted then the Electric Vehicle senses the depletion of #4. At that point the Electric Vehicle switches back to #1 Battery Pack. When the Vehicle switches back to # 1 Battery Pack it is charged and ready to be used in powering the Electric Vehicle. When #1 comes on line in powering the Electric Vehicle, # 4 enters the recharging process and the Battery Alternating Recharging Process starts over. The Process repeats itself over and over.

1. Claim 1, is the use of 2 or more Batteries or Battery Packs in the Battery Alternating Recharging Process. The Process starts with 1 battery or battery pack. When number 1 battery is depleted, number 2 battery or pack comes into use. When number 2 battery or pack is depleted, number 3 battery or pack comes into use. When number 3 battery or pack is depleted, number 4 battery or pack comes into use. When number 4 battery or pack is depleted. The number 1 battery or pack is recharged and is ready to reenter the electric vehicle operation. Thus; the description, Electric Vehicle Battery Alternating Recharging Process.
These Battery Packs are made up of individual Batteries. The number of Batteries or Battery Packs varies in each application. The number is determined by reaching the desired distance and time needed for the Electric Vehicle to travel. This number of batteries can be as many as 2 batteries, or an infinite number according to the desired application to attain specific needs.

2. Claim 2, is the Alternating use of the Batteries or Battery Packs for the purpose of recharging an Electric Vehicle's batteries while in motion or while being driven, in essence when in operation. The Electric Vehicle does not have to be stopped or parked and connected to a power source for the means of recharging the batteries. This Process will allow the freedom from the power connection to charge the Electric Vehicle.

3. Claim 3, is the broad use of the Battery Alternating Recharging Process described in this Patent application. For an example, Airplanes, Helicopters, Military Vehicles of all types, as an example a Hum V. The Hum V would become a mobile power station that would supply electric power for all needs in the field of operations, such as war zones.
Other examples are all types of Sea going Vessels, Military, Passenger, Freight vehicles. Other examples, Trains, Passenger or Freight. To further give example's of the many use's of the Battery Alternating Recharging Process are; Apartment complex's or a housing development such as a Sub Division. The process would work as supplying power to the homes and apartments with a central power station supplying the power to operate the Battery Alternating Recharging Process in which the homes and apartments are equipped. One last example a Hiker or Military Person would use the Process as a Nano Power Source in a back Pack for electric power. This application would power all the individuals electric power needs, camping, or in the hostile field of operations, in desolate places, war zones. Claim 3, in essence; The Battery Alternating Recharging Process can supply electric power for all electric power needs in any environment.
